(19) United States
(12) Patent Application Publication
(10) Pub. No.: US 2005/0262237 A1
(43) Pub. Date: Nov. 24, 2005

(54) Dynamic incident tracking and investigation in service monitors

(75) Inventors: Cathy Anne Fulton, Austin, TX (US); Benjamin Paschal Haley, Austin, TX (US); Jason Joseph Spofford, Austin, TX (US)

Correspondence Address: Law Office of William N. Nulsey, 2000 Canonero, Austin, TX, 78746, US

(73) Assignee: NetQos, Inc.

(21) Appl. No.: 10/962,331

(22) Filed: Oct. 8, 2004

Related U.S. Application Data
(60) Provisional application No. 60/563,535, filed on Apr. 19, 2004.

(51) Int. Cl. G06F 15/173

(52) U.S. Cl. 709/224

(57) ABSTRACT

A method for a service monitor of a computing environment includes monitoring application network transactions and behaviors for the computing environment, the computing environment including client subnets accessing servers, the monitoring independent of client site monitors; decomposing the monitored transactions and behaviors into network, server and application quality components; using the components to identify services, servers and client subnets as associated with a quality issue; and implementing an active investigation on the services, servers and client subnets to gather statistical data to assist root cause analysis independent of a network monitoring interruption; The quality issue might be a performance issue, such as excessive response times, excessive loss rates, or small transfer rates. The quality issue might be an availability issue, such as an unreachable network node or a missing web page. The service monitor includes an event detection module configured to decompose the monitored transactions and behaviors into network, server and application quality components and to use the components to identify services, servers and client subnets as being associated with a quality issue. The monitor also includes active investigation modules networked to gather statistical data according to criteria to assist root cause analysis without monitoring interruption.

### FIELD OF THE INVENTION

This invention pertains to network, server, and service monitoring; more specifically, it pertains to dynamic identification, tracking, and investigation of service performance and availability incidents based on monitoring of application network communications. The service may be provided by a single device, a network of devices, applications running on a device or network, etc.

### BACKGROUND OF THE INVENTION

Almost from the earliest days of computing, users have been attaching devices together to form networks. Several types of networks include local area networks (LANs), metropolitan area networks (MANs) and wide area networks (WANs). One particular example of a WAN is the Internet, which connects millions of computers around the world.

Networks provide users with the capacity of dedicating particular computers to specific tasks and sharing resources such as a printer, applications and memory among multiple machines and users. A computer that provides functionality to other computers on a network is commonly referred to as a server. Communication among computers and devices on a network is typically referred to as traffic.

Of course, the networking of computers adds a level of complexity that is not present with a single machine, standing alone. A problem in one area of a network, whether with a particular computer or with the communication media that connects the various computers and devices, can cause problems for all the computers and devices that make up the network. For example a file server, a computer that provides disk resources to other machines, may prevent the other machines from accessing or storing critical data; it thus prevents machines that depend upon the disk resources from performing their tasks.

Network and MIS managers are motivated to keep business-critical applications running smoothly across the networks separating servers from end-users. They would like to be able to monitor response time behavior experienced by the users, and to clearly identify potential network and server bottlenecks as quickly as possible. They would also like the management/maintenance of the monitoring system to have a low man-hour cost due to the critical shortage of human expertise. It is desired that the information be consistently reliable, with few false positives (else the alarms will be ignored) and few false negatives (else problems will not be noticed quickly).

Existing response-time monitoring solutions fall into one of three main categories: those requiring a client-site agent (an agent located near the client, on the same site as the client); subscription service; and solutions for specialized applications only. These existing solutions are briefly described below.

There are several existing response-time monitoring tools (e.g., NetIQ's Pegasus and Compuware's Ecoscope) that require a hardware and/or software agent be installed near each client site from which end-to-end or total response times are to be computed. The main problem with this approach is that it can be difficult or impossible to get the agents installed and keep them operating. For a global network, the number of agents can be significant; installation can be slow and maintenance painful. For an eCommerce site, installation of the agents is not practical; requesting potential customers to install software on their computers probably would not meet with much success. A secondary issue with this approach is that each of the client-site agents must upload their measurements to a centralized management platform; this adds unnecessary traffic on what may be expensive wide-area links. A third issue with this approach is that it is difficult to accurately separate the network from server delay contributions.

To overcome the issue with numerous agent installs, some companies (e.g., KeyNotes and Mercury Interactive) offer a subscription service whereby one may use their preinstalled agents for response-time monitoring. There are two main problems with this approach. One is that the agents are not monitoring “real” client traffic but are artificially generating a handful of “defined” transactions. The other is that the monitoring does not generally cover the full range of client sites—the monitoring is limited to where the service provider has installed agents.

A third approach used by a few companies is to provide a monitoring solution via a server-site agent (an agent located near the server, on the same site as the server), rather than a client-site agent. The shortcoming with some of these tools is that they either support only a single application (e.g., SAP/R3 or web), or that they are using generated Internet control message protocol (ICMP) packets rather than the actual client application packets to estimate network response times, or that they assume a constant network response time throughout the life of a TCP session. The ICMP packets may be treated very different than the actual client application packets because of their protocol (separate management queue and/or QoS policy), their size (serialization and/or scheduling discipline), and their timing (not sent at same time as the application packets). Network response times typically vary considerably throughout a TCP session. Other of these tools, such as the NetQoS(™) SuperAgent(™) service monitor, does not have these shortcomings.

A common monitoring technique is to dedicate a particular device, such as a probe or server, to passively monitor the service (provided by a network, system, and/or application) in order to identify troublesome traffic. However, this method does not distinguish whether a particular busy period represents a normal or abnormal deviation. For example, at the start of a business day it may be common for many users to simultaneously log in to their machines and access a given application, generating a spike in network traffic. Further, during a holiday period, a business network may normally have very little or no traffic.

Another common monitoring technique is the use of active agents to periodically test (or probe) the network, including computers and devices connected to the network and any particular services those computers and devices provide. If such an agent is scheduled to run every fifteen (15) minutes, then this implies that on average it will detect a sustained outage after seven and one half (7.5) minutes have elapsed. Intermittent, brief outages may very well go undetected. More frequent probing allows the agent to detect sustained outages more quickly and increases the probability the agent will detect intermittent issues; but more frequent probing places an additional, and sometimes unacceptable, load on the environment.

Developers continue to improve methods and systems for testing networks, servers and services for availability and performance. Among what is needed is a reliable method and system for monitoring networks, servers and services for availability and performance that provides sufficiently accurate information while avoiding excessive load on the networks, servers and services. Another issue, however, is the complexity of interpreting the rich dense data that arises from the monitoring. Among what is needed is intelligent automation that identifies issues and probably causes.

### BRIEF SUMMARY OF THE INVENTION

Embodiments are directed to providing a system and method of monitoring a data network and its services that incorporates both passive and active approaches and thereby benefits from the advantages of both approaches while avoiding the drawbacks of either. In a manner suitable for LANs, Manes and WANs, a Service Monitor provides server-side monitoring of a computing environment. The method includes monitoring application network transactions and behaviors for a computing environment including one or more client subnets accessing a service provided by one or more servers; decomposing the monitored transactions into network, server and application delay components; using the original and decomposed delay components to identify application(s), server(s) and/or client subnet(s) associated with a response-time issue; and implementing an active investigation on the applications and/or servers and/or client subnets. Additionally, the method includes monitoring application network transactions for a computing environment including one or more client subnets accessing a service provided by one or more servers; deriving non-delay quality metrics (e.g., loss rates, good put) from the monitored transactions; using these quality metrics to identify application(s), server(s) and/or client subnet(s) associated with a quality issue; and implementing an active investigation on the applications and/or servers and/or network devices and/or client subnets. The active investigation includes gathering statistical data to assist root cause analysis without causing an interruption of service monitoring.

The invention provides a method of monitoring a data network and its services that incorporates both passive and active approaches and thereby benefits from the advantages of both approaches while avoiding the drawbacks of either. In a manner suitable for LANs, Manes and WANs, a Service Monitor collects information related to service traffic on a target network. The information is correlated to specific devices on the network and specific services provided by the devices. The correlated information is employed to construct a profile of the network's traffic as the traffic relates to devices and services. The profile is used to monitor the network for periods of either less than or more than typical amounts of traffic corresponding to the devices and services. If such a period is detected, then intelligent agents investigate to determine whether or not a problem exists.

In addition, parameters are defined for “exclusion periods,” i.e. particular times that information is not collected. For example, during a Monday holiday, a business network might typically be expected to show less than the common data traffic for a service(s). Similarly during server maintenance windows, server traffic would be atypical. By excluding this data from the generation of a profile of typical Monday business days, a more accurate profile is generated.

In one embodiment, the method includes analyzing the decomposed components and derived metrics to identify anomalies, reduce alarms, perform an active investigation, and further isolate an identified problem. The decomposing can be based on response size. If the element with an identified problem is a server, the statistical data can include server statistics, and if the element with an identified problem is a client subnet, the statistical data can include network statistics.

The active investigation can include either a continuous mode or a snapshot mode. A snapshot mode can be operational only when triggered by an event, the snapshot mode providing a snapshot of performance around a predetermined period of time, such as about five to 15 minutes from the beginning of an event. The snapshot does not have to include context or historical information. The continuous mode can poll a source of network or server or service information continuously to provide a performance history and store and report performance data in a database for storing the event detection data concerning anomalies in the computer environment. Also, the continuous mode can store and report performance data in a dedicated database for active investigations.

In another embodiment, the monitoring is server-side monitoring that includes event detection capable of identifying sudden, gradual, and/or periodic anomalies in the service via auto-thresholding according to one or more baselines. The baselines can include one or more of baselines based on a past week, based on a same day of week over three months, based on a same day of week and similar day of month over six months, based on an hourly calculation, based on work days, or based on user-configured time periods. The baselines may use time filters to exclude “atypical” time periods—such as maintenance windows. The baselines may use other criteria to exclude “atypical” time periods, such as time intervals containing a very low number of measurements. The auto-thresholding can calculate a single threshold from a weighted average of each baseline calculation, or the server-side monitoring can include checking data against each baseline threshold individually and record any baseline violated, each violation indicative of a different problem.

A violation can be of a 6-month baseline threshold but not a 7-day baseline threshold, which indicates a gradual increase condition, in which case the active investigation includes inspecting time-series event data.

Another embodiment is directed to a service monitoring system configured to monitor application network transactions and behaviors for the computing environment. The system includes an event detection module capable of operating independent of client site monitors, the event detection module configured to decompose the monitored transactions and behaviors into at least network, server and application delay components and to use the original and decomposed delay components along with other derived quality metrics to identify one or more of the services, servers, networks and client subnets as being associated with a response-time or other quality issue. The system further includes one or more active investigation modules coupled to the event detection modules, the active investigation modules configured to investigate the one or more services, servers and client subnets according to criteria determined by the event detection module, the active investigation module configured to gather statistical data to assist root cause analysis independent of a service monitoring interruption. The system can include a data store coupled to the service monitor, the data store configured to hold one or more of historic data, sensitivity data, threshold data, server settings, investigation settings, incident data, current configuration data and metrics collected by the service monitor.

In one embodiment, the system event detection component interacts with a second monitoring system disposed in a network performance agent, the network performance agent disposed near one or more clients or servers. The event detection component can act on data from multiple service monitors distributed across the globe. Active investigations are launched from the appropriate service monitors to collect relevant information pertaining to the service degradation.

These and other advantages of the invention, as well as additional inventive features, will be apparent from the description of the invention provided herein.

This summary is not intended as a comprehensive description of the claimed subject matter but, rather is intended to provide a short overview of some of the matter's functionality. Other systems, methods, features and advantages of the invention will be or will become apparent to one with skill in the art upon examination of the following FIGUREs and detailed description. It is intended that all such additional systems, methods, features and advantages be included within this description, be within the scope of the invention, and be protected by the accompanying claims.

For a more complete understanding of the present invention, and the advantages thereof, reference is now made to the following brief descriptions taken in conjunction with the accompanying FIGUREs, in which like reference numerals indicate like features.

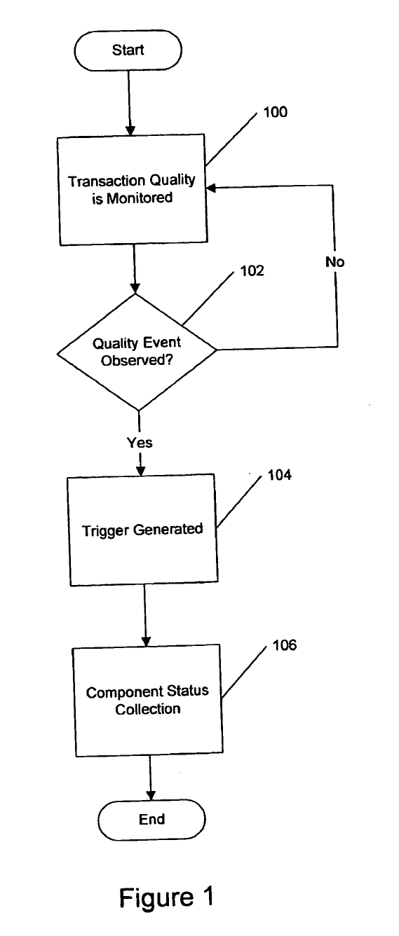

FIG. 1 is a block drawing of an exemplary system architecture that supports the claimed subject matter.

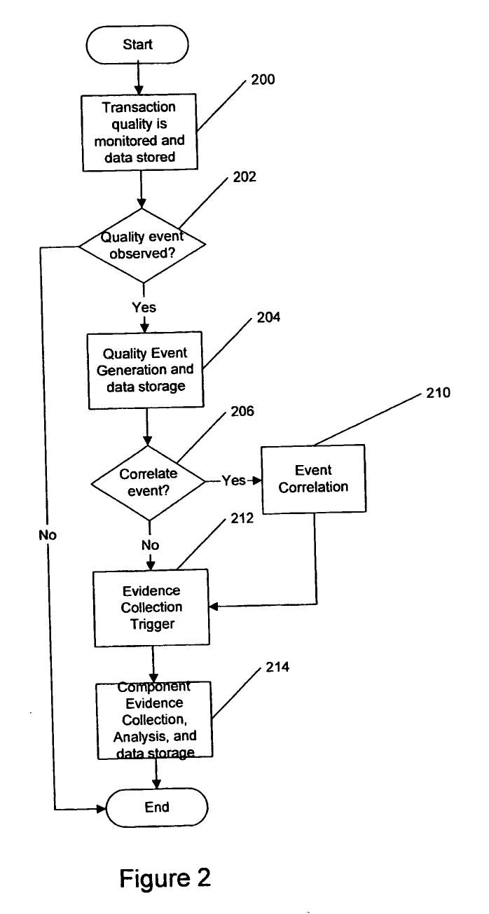

FIG. 2A is a block drawing of an exemplary computing environment that supports the claimed subject matter.

FIG. 2B is a block diagram of a Service Monitor introduced in FIG. 2A.

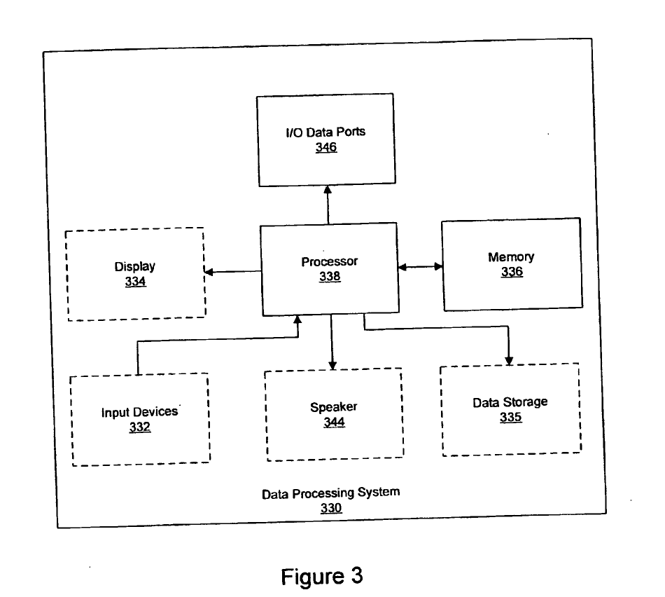

FIG. 3 is a flowchart of an exemplary Service Monitoring process that implements a portion of the claimed subject matter according to an embodiment of the present invention.

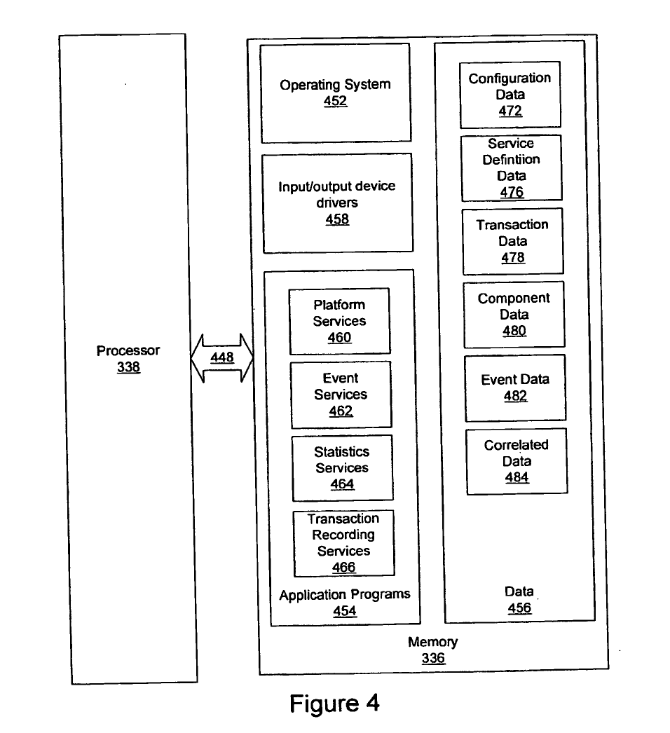

FIG. 4 is a flowchart of a Service Monitoring step, described in more detail, of the Service Monitoring process described in FIG. 3 according to an embodiment of the present invention.

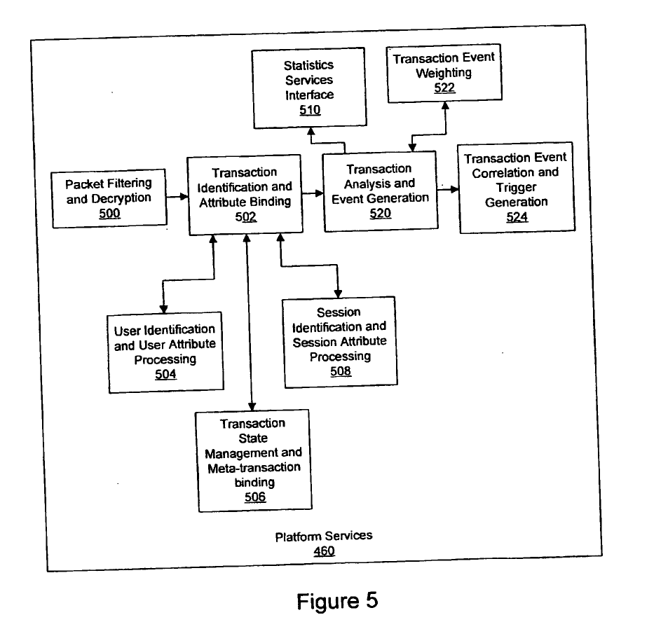

FIG. 5 is a flow diagram illustrating a method according to an embodiment of the present invention.

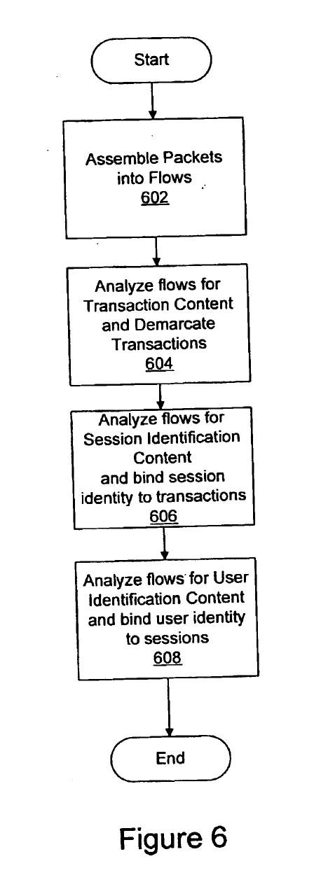

FIGS. 6A and 6B are block diagrams illustrating an Active Investigation component in accordance with an embodiment of the present invention.

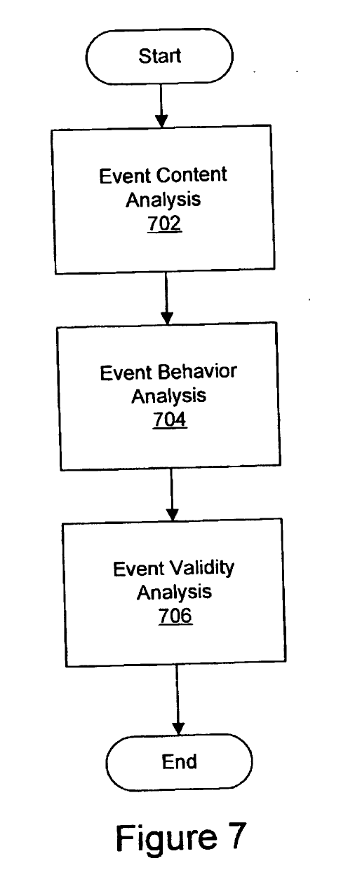

FIG. 7 is a flowchart of a portion of an Examine Metrics process for analyzing the data collected by the Service Monitoring process of FIGS. 3 and 4 according to an embodiment of the present invention.

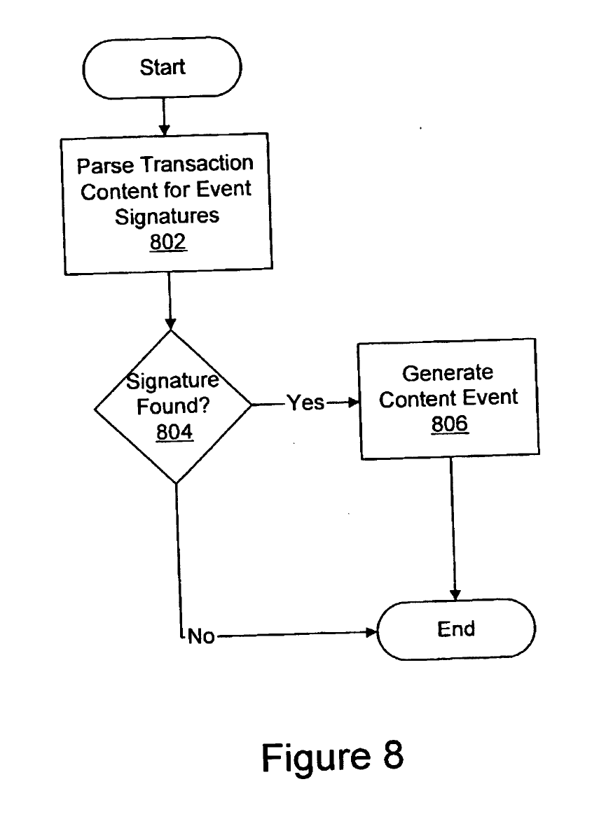

FIG. 8 is a flowchart of the remaining potion of the Examine Metrics process introduced in FIG. 7 according to an embodiment of the present invention.

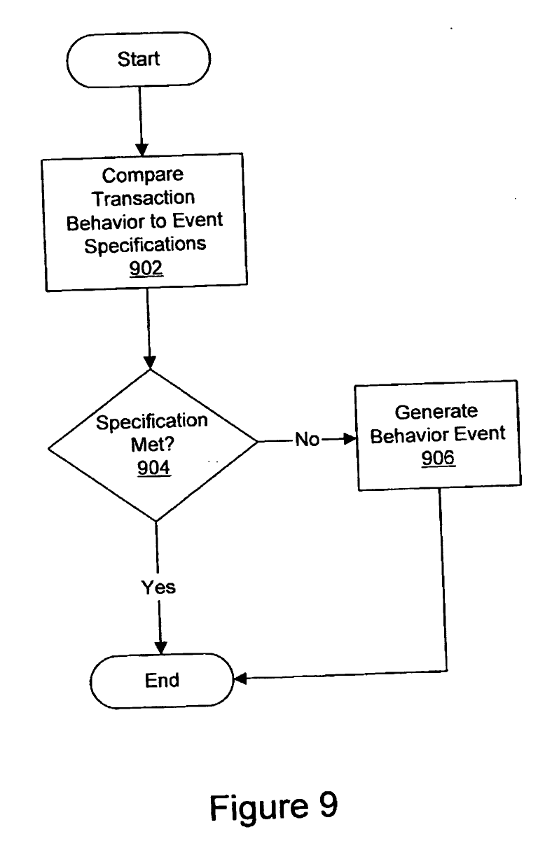

FIG. 9 is a flowchart of a Collect Data process that implements a portion of the claimed subject matter according to an embodiment of the present invention.

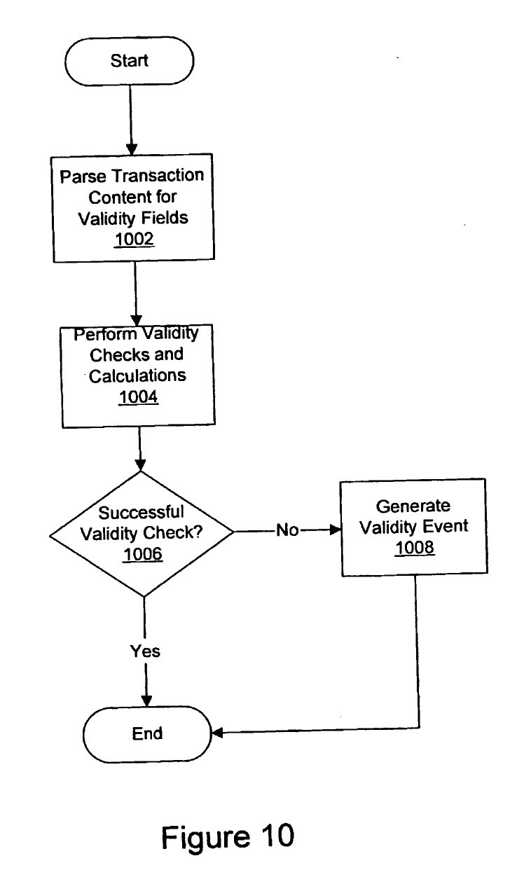

FIG. 10 is a dataflow diagram showing the source of a Threshold cache employed in the claimed subject matter according to an embodiment of the present invention.

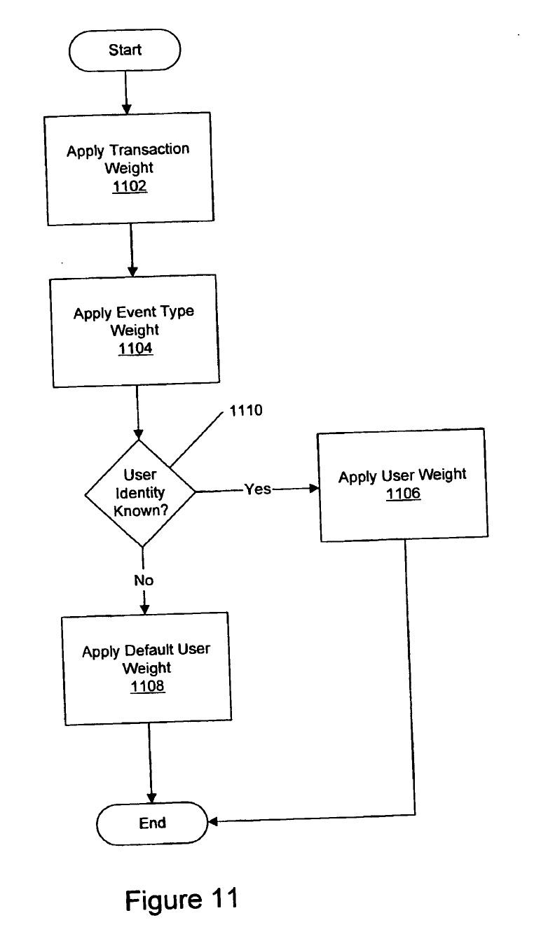

FIG. 11 is a flowchart of an Investigate process that is part of the Active Portion of the Service Monitors of FIG. 2B according to an embodiment of the present invention according to an embodiment of the present invention.

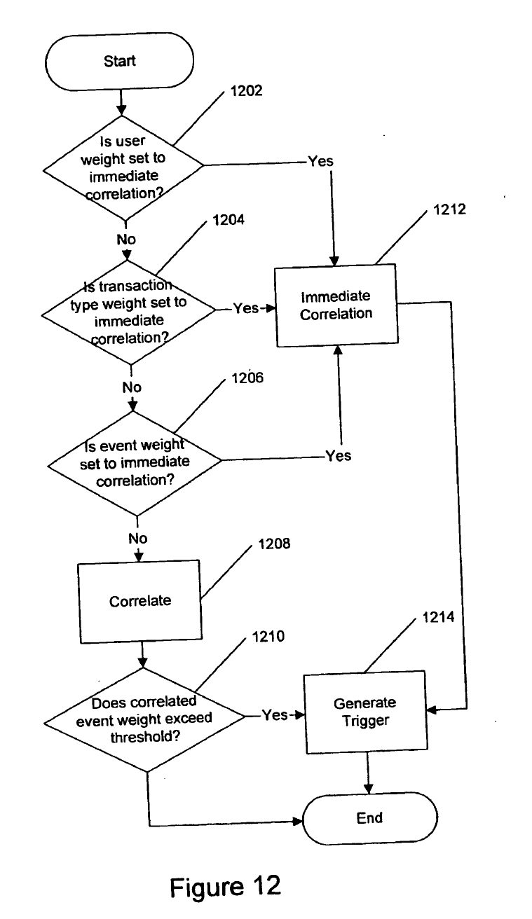

FIG. 12 is a flowchart of an Examine Incidents process according to an embodiment of the present invention.

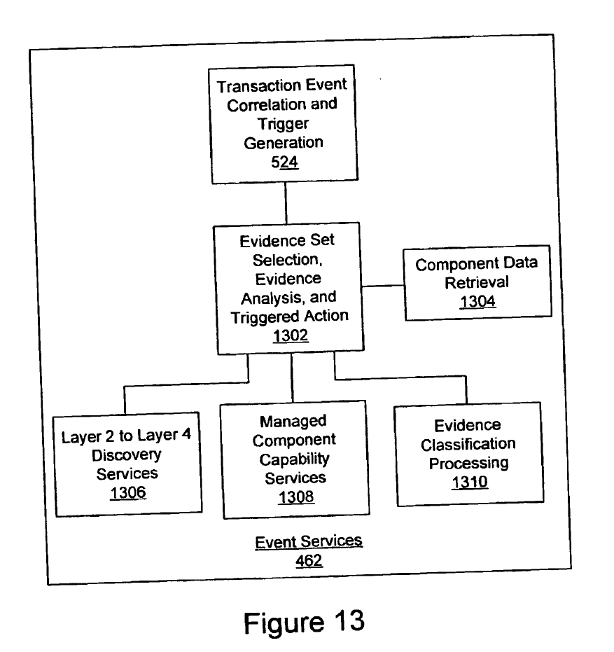

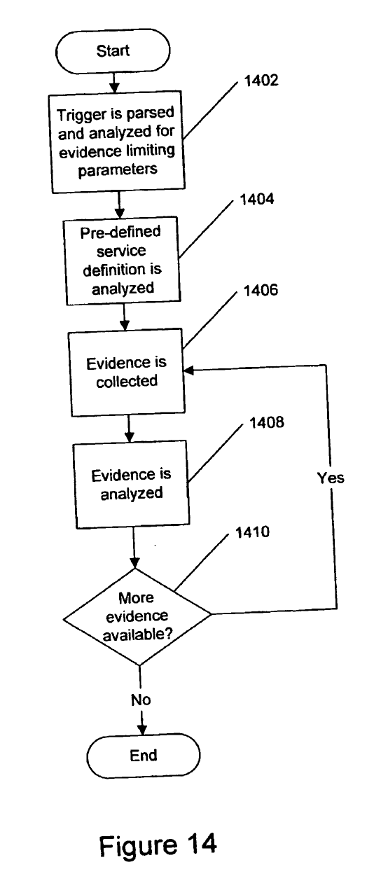

FIGS. 13a and 13b are flow diagrams illustrating an Examine Issues process flowing from FIG. 12 according to an embodiment of the present invention.

### DETAILED DESCRIPTION OF THE FIGURES

Although described with particular reference to a computing environment that includes personal computers (PCs), a wide area network (WAN) and the Internet, the claimed subject matter can be implemented in any information technology (IT) system in which it is necessary or desirable to monitor performance of a network and individual system, computers and devices on the network. Those with skill in the computing arts will recognize that the disclosed embodiments have relevance to a wide variety of computing environments in addition to those specific examples described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, PC or mainframe.

All references, including publications, patent applications, and patents, cited herein are hereby incorporated by reference to the same extent as if each reference were individually and specifically indicated to be incorporated by reference and were set forth in its entirety herein.

In the context of this document, a “memory,” “recording medium” and “data store” can be any means that contains, stores, communicates, propagates, or transports the program and/or data for use by or in conjunction with an instruction execution system, apparatus or device. Memory, recording medium and data store can be, but are not limited to, an electronic, magnetic, optical, electromagnetic, infrared or semiconductor system, apparatus or device. Memory, recording medium and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

FIG. 1 is a block drawing of an exemplary computing environment 100 that supports the claimed subject matter. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments wherein tasks are performed by remote processing devices that are linked through a communications network. In a distributed computing environment, program modules may be located in local and/or remote computer storage media including memory storage devices.

With reference to FIG. 1, an exemplary system within a computing environment for implementing the invention includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules 46 and program data 47. Note that these components can either be the same as or different from operating system 34, application programs 35, other program modules 36, and program data 37. Operating system 44, application programs 45, other program modules 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 94 or the like.

The computer 10 may operate in a networked environment using logical connections to one or more remote computers, such as a remote computer 80. The remote computer 80 may be a personal computer, a server, a router, a network PC, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the present invention, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN networking environment, the computer 10 is connected to the WAN 127 through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that several of the acts and operation described hereinafter may also be implemented in hardware.

Referring now to FIG. 2A, a block diagram illustrates computing environment 100. Computing environment 100 includes WAN 127 coupled to computer systems 137 and 139, Service Management Console 131, and Service Monitors 125(1,2,3), and Internet 135. Internet 135 is shown coupled to WAN 127 via router 117(1). A Service Monitor sits off a network tap between WAN 127 and Server Farm 109, which can be coupled to one or more computer systems 137. Another Service Monitor sits off a span or mirror port of router 117(1) such that it sees traffic going to and from WAN 127, Internet 135, Application Server 111 and/or File Server 113. Application Server 111 is shown coupled to data store 113, which further holds one or more Shared Applications 115. Coupled to Service Management Console 131 and Service Monitor 125(3) is data store 123. In this example, data store 123 is a shared resource, i.e. other systems such as computer systems 137 and 139 could share data on data store 123, as could servers in Server Farm 109.

Each of Service Monitors 125(1,2,3) can be configured to implement all or some of the claimed subject matter and can be executed on one or more servers coupled to WAN 127, such as file server 121. The data provided by each of the Service Monitors is analyzed as a whole, such that each Service Monitor may provide additional insight and information into the source of the issue. Service Monitors 125 (1,2,3) could also be implemented on other computing systems, such as computing system client 101, on a dedicated application server such as application server 111, or on routers 117(1,2). Service Monitors 125(1,2,3) are explained in more detail below. Data store 113 can store an exemplary shared application 115. One example of a commonly shared application is a database management system (DBMS). One with skill in the computing arts should be familiar with applications and types of applications that are commonly implemented as shared applications.

Server 121 can be connected to the Internet or another LAN/WAN via any suitable communication medium such as, but not limited to, a dial-up telephone line, a digital subscriber line (DSL) or some type of wireless connection. Thus, file server 121 can be configured to provide a gateway, or access point to one or more computer networks, including the Internet.

Referring now to FIG. 2B, a block diagram of one of Service Monitors 125(1,2,3) introduced in FIG. 2A, is shown in more detail. Service Monitors 125(1,2,3) can each include a passive component 151 and an active component 153, which together provide an efficient means of monitoring computing environments such as those on a LAN, WAN, MAN or other network. Both passive component 151 and active component 153 are coupled to an analysis component 155 which may be on a separate device. Components 151, 153 and 155 are described in more detail below in conjunction with FIGS. 3 and 4.

As shown in FIG. 2A, Service Monitors 125(1,2,3) can be located in several locations in computing environment 100 and interact with a data storage location, such as data store 123, for example. As shown, a Service Monitor is coupled to data store 123, to Server Farm 109 and to servers 111 and 113. Service Monitors can further be located in router 117, off a device mirror port, off a network tap, or inline. The location of the Service Monitors can be determined according to system requirements and according to the information about the network a user finds of interest. Data store 123 stores several types of data for one or more of Service Monitors 125(1,2,3), including historic data 157, sensitivity data 159, threshold values 161, server settings 163, investigation settings 165, incident data 167, current configuration data 169 and current metrics data 171. Data files 157, 159, 161, 163, 165, 167, 169 and 171 are described in more detail below in conjunction with FIGS. 3-13b.

As described below, the computing environment 100 illustrates Service Monitors 125(1,2,3) that provide monitoring processes that report service behavior based on both active and passive monitoring and investigations. Advantageously, the Service Monitors operate either independent of agents at client sites or with agents at client sites. The Service Monitors may be placed anywhere along the network path, but the optimal (maximum benefit for the cost) locations are usually at the data centers. As described below, embodiments are directed to processes that operate within Service Monitors 125 to provide monitoring, which can include active or passive monitoring and can include application performance monitoring and service availability monitoring. More particularly, some embodiments are directed to determining appropriate active investigations based on passive observations. In one embodiment, Service Monitors actively investigate only when conclusions based on passive observations indicate that an active investigation is appropriate due to performance degradation. In another embodiment, a method is described that determines service availability according to a traffic determination attributable to a service.

Low Overhead Service Availability Monitoring

FIG. 3 is a flowchart of an exemplary Service Monitoring 200 process that implements a portion of the claimed subject matter and could be implemented as a part of Service Monitors 125(1,2,3) (FIGS. 2A and 2B). For exemplary purposes, process 200 can be executed on file server 121 of computing environment 100 shown in FIG. 2A. Portions of process 200 correspond to passive component 151 (FIG. 2B) of Service Monitors 125(1,2,3) and portions correspond to active component 153 (FIG. 2B). Process 200 begins in a “Start Availability Check” 201 and control proceeds immediately to a “Check Device Availability” step 203 during which process 200 selects a device on computing environment 100 shown in FIG. 2A and analyzes the results of its continuous passive monitoring of that device's activity. The selected device, or “targeted device,” is the first unexamined device listed in Current Configuration 169 (FIG. 2B). Current Configuration 169 contains, among other information, a list of the devices and corresponding services that process 200 is responsible for monitoring. In other words, process 200, through multiple iterations through the illustrated steps, examines each device listed in Current Configuration 169. This portion of process 200 corresponds to a portion of passive component 151 (FIG. 2B) of Service Monitors 125(1,2,3). Note that the passive monitoring is continuous for all configured devices; the analysis of the collected data is performed for each device.

Examples of devices that might be the target of step 203 are computing system 10, file server 121, print servers, and connections to the Internet. Once a particular device is selected for monitoring, control proceeds to a “Check Services” step 205 during which process 200 monitors the services associated with the particular device selected in step 203. Check Services step 205 is described in more detail below in conjunction with FIG. 4.

Following step 205, control proceeds to a “Was Any Service Detected?” step 207 during which process 200 determines whether or not any of the services associated with the particular device selected for monitoring in step 203 has been determined to be available during Check Services step 205. The theory is that, if a service is available, then the monitored device must also be available. If one service has been determined to be available, then control proceeds to a “Device Is Up” state 213. In one embodiment, if so configured, the state of the device can be stored in Current Metrics 171 of data store 123 (FIG. 2B) along with any other relevant information about the targeted device that may have been collected. Examples of relevant data include, but are not limited to, such data as network traffic metrics and number and location of users that have communicated with the device.

If, in step 207, process 200 determines that no service associated with the selected device is available, then control proceeds to a “Probe Device” step 209 during which process 200 attempts to establish a connection or otherwise communicate with the targeted device. The transition from step 207 to step 209 represents a transition from passive component 151 to active component 153 in that a passively-detected condition indicates that affirmative action needs to be initiated to determine the state of the particular targeted device.

The particular method used to establish this connection depends upon the type of device. For example, if the targeted device is computing system 139, then an ICMP ping command may be sent to computing system 139 using an Internet protocol (IP) address associated with computing system 139 to determine whether or not computing system 139 is on-line or off-line. The device could also be a router.

Control proceeds from step 209 to a “Device Response?” step 211 during which process 200 determines whether or not the communication attempted in step 209 was successful. If the communication, whether a ping command or some other communication, was successful, then control proceeds to “Device Is Up” state 213 and metrics can be recorded if desired. If the attempted communication was not successful, then control proceeds to a “Device Is Down” state 215. If metrics are recorded, information gathered during steps 207, 209 and 211 corresponding to the current state, as indicated by one of states 213 and 215, and observed activity corresponding to the targeted device is stored in Current Metrics 171 of data store 123. Control then proceeds to “More Devices?” step 219 during which, process 200 determines whether or not each device listed in Current Configuration 169 has been monitored by process 200.

If there are unexamined devices listed in Current Configuration 169 that have not yet been processed in the current iteration of process 200, then control returns to Check Device Availability step 203, the next device in Current Configuration 169 is selected as the target and processing continues as described above. If, in step 219, process 200 determines there are no more devices to be monitored, then control proceeds to a “Sleep” step 221 during which a predefined interval of time is allowed to pass. Following the predefined interval of time, control then returns to Start Availability Check step 201 and processing continues as before starting from the top of the device list of Current Configuration 169. In other words, periodically, based upon the length of the predefined interval, process 200 monitors each device and service listed in Current Configuration 169.

It should be noted that process 200 does not include an “End” step in which processing is complete because, once initiated, process 200 continues to periodically analyze the devices and services of computing environment 100 shown in FIG. 2A until process 200 is explicitly terminated. Typically, analysis takes place every fifteen (15) minutes or so, but this interval can be set longer or shorter depending upon the needs of computing environment 100 shown in FIG. 2A. A termination can occur if the computing system executing process 200 is shut down or process 200 is terminated by a system administrator via a control panel (not shown).

FIG. 4 is a flowchart of Check Services step 205 of Service Monitoring 200 process, described above in conjunction with FIG. 3. More particularly, FIG. 4 illustrates a process for application services checking. The process of step 205 begins in a “Start Service Check” 231 and control proceeds immediately to a “Check Next Service Availability” step 233, during which process 200 selects an unexamined service, or “targeted service,” associated with the currently targeted device from Current Configuration 169 and conducts a passive monitoring of the services' activity. This passive monitoring corresponds to passive component 151 (FIG. 2B) of Service Monitors 125(1,2,3) (FIG. 2B).

One example of a service that might be the target of step 233 could include services provided by a router, a server, a switch and the like and the service can include an application, the operability of a URL, routing services and the like. Once a particular service is selected for monitoring, control proceeds to a “Has Valid Traffic Been Seen for the Service?” step 235 during which process 200 analyzes the targeted service and determines whether or not there has been recent traffic corresponding to that service. Note that traffic for all configured services is passively monitored continuously; step 235 refers to the analysis of the monitoring for the selected service.

If service is detected, then control proceeds to a “Service Is Up” state 241. At this time, if so configured, metrics can be recorded and results of process' 200 observations can be stored in Current Metrics 171 of data store 123 (FIG. 2B). Examples of relevant data include, but are not limited to, such data as network traffic metrics and number and location of users that have communicated using the service on that device.

If, in step 235, process 200 does not observe traffic that can be associated with the targeted service, then control proceeds to a “Can Use of Service Be Acquired?” step 237 during which process 200 requests performance of a task associated with the targeted service. The transition from step 235 to step 237 represents a transition from passive component 151 to active component 153.

The particular task requested depends, upon the type of service. For example, if the targeted service relates to network connectivity, then a “trace route” command can be sent to determine if the destination is reachable from the source. As another example, if the targeted service is a web application transaction, then an appropriate HTTP command(s) can be sent to the server to determine whether or not that transaction is available.

In step 237 process 200 determines whether or not the service requested was successfully completed. If so, then control proceeds to “Service Is Up” state 241. If the requested task is not completed, then control proceeds to a “Service Is Down” step 243.

If configured, metrics can be recorded related to information gathered during steps 235, 237 and 239 corresponding to the current state, as indicated by one of states 241 and 243, and observed activity of the targeted service is stored in Current Metrics 171 of data store 123. Control then proceeds to an “Another Service?” step 247 during which process 200 determines whether or not each service listed in Current Configuration 169 that corresponds to the targeted device has been monitored by process 200. As explained above in conjunction with FIG. 3, Current Configuration 169 contains a list of the devices and corresponding services that process 200 is responsible for monitoring.

If there are additional services corresponding to the targeted device listed in Current Configuration 169 that have not yet been examined in the current iteration of process 200, then control returns to Check Next Service step 233 and processing continues as described above with the next unexamined service as the target of process 200. If, in step 247, process 200 determines there are no more service to be monitored, then control proceeds to an “End Service Check” step 249 in which processing associated with step 205 is complete. Control then returns to Was Any Service Detected? step 207 (FIG. 3).

Referring now to FIG. 5, a flow diagram illustrates a method 500 describing the process illustrated in FIGS. 3 and 4. More particularly, the method begins with “Start Determine Availability” block 501. Block 510 provides for identifying one or more services for which availability is unknown. The service can be one or more services such as an application, a universal resource locator (URL), a transaction service, a routing service, a transmission service, a processing service and the like. If more than one device provides the services for which availability is required, the identifying services can include iterating through each service on each device in a network or subnet. Thus, if a network includes several devices that provide services, the method includes iterating through each service present on each device. A network can include a server, router, switch, interface or the like that each provide one or more services. Block 520 provides for determining whether traffic has been present for a predetermined period attributable to the service for a particular device on the network. Block 530 provides for determining whether valid traffic for that the service occurs during the predetermined period. If not, block 540 provides for determining that the service is unavailable because valid traffic failed to occur during the predetermined period. If there is valid traffic, block 542 determines that service is available. Block 550 provides that if valid traffic does not occur during the predetermined period, determining whether the device is operable. To determine whether the device is operable, a “ping” operation, an HTTP command or TCP connection call or the like can be performed. As one of skill in the arts will appreciate, the type of testing of a device depends on the type of device. The method ends at “End” block 560. As discussed above, the operation could be repeated at scheduled intervals or as needed as discussed above.

Augmenting Passive Probes with Active Investigations

FIGS. 3 through 5 provide a method for determining availability of services. Service Monitors 125(1,2,3) can also implement network monitoring processes to collect performance or quality data via passive and active approaches and store the results in databases such as data store 123 or data store 113, or in memory attached to Service Monitors 125(1,2,3).

Referring now to FIG. 6A, Service Monitors 125(1,2,3) and Service Management Console 131 (FIG. 2A) can be configured to operate with an investigation console component 600. Investigation console component 600 can be configured to operate either as a standalone component or in combination with other components, such as Service Monitors like SuperAgent™ or other performance agents, to determine the root cause of application performance problems. Performance agents can include monitors that do not rely on client side agents. Alternatively, in one embodiment, client side active agents can be implemented in conjunction with active investigation console component 600 to provide measurement and analysis of specific transactions and to allow users to schedule tests and perform availability testing such as that illustrated in FIGS. 3-5. Client side passive agents can also be implemented in conjunction with investigation console component 600 to measure User Datagram Protocol (UDP) based application and Transmission Control Protocol (TCP) applications. In one embodiment, several distributed performance agents can be coupled to a single investigation console component 600.

According to an embodiment, performance agents can be situated near server farms, such as within Service Monitor 125(2) near server farm 109 shown in FIG. 2A. Thus, Service Monitor 125(2) can operate to monitor application response times and traffic volumes for each client subnet accessing the server without requiring devices or agents at client sites, such as client 101. Performance agents can be configured to decompose total response times into network, server, and application delay components. The decomposition can be based on response size so that a 50-Kbyte download is treated differently from a 1 Megabyte download. According to an embodiment, investigation console component 600 interacts with a performance agent having additional functionality to provide more detailed data concerning the source of a problem. More specifically, in an embodiment, a performance agent can provide data to investigation console component 600 that allows detailed anomaly detection, intelligent alarm reduction, optional active investigations and detailed problem diagnostics. Additional functions can include event correlation, automated investigation, historical trend analysis, real time analysis, device polling for performance measures and alarm triggered trace routes. The additional functionality is due to additional data collected via an extension of a performance agent, a module attached to a performance agent or the like, referred to herein as an active investigation system.

Investigation console component 600 can be implemented within a server, such as file server 121, operable as Web Server 610. Server 610 is configured to implement Investigator Web Interface 620 and Event Handler Web Service 630. Investigator Web Interface 620 is operable to provide security for operating command line tools 640. Command line tools can include ping, trace route, TCP echo, TCP trace route, performance agent query and Simple Network Management Protocol (SNMP) query. Event Handler Web Service 630 can be implemented as an alarm handler web service that accepts alarms from agents. The alarms are logged in Investigator database 650. If an alarm occurs, a signal to expert system 660 takes place. Investigation console component 600 can be coupled to a plurality of performance agents. For example, Service Management Console 131 can include an investigation console component, and each of Service Monitors 125 can include a performance agent that includes a module or the like to integrate with the investigation console component. FIG. 6 illustrates that Service Monitor 125 can be coupled console 600 either directly or indirectly as shown by hashed line connection. Service Monitor 125, in an embodiment, includes a performance agent 670 and an event detection component 680. As shown, Service Monitor 125 can be coupled to server farm 109.

In one embodiment, the module provides an active component coupled to an otherwise passive performance agent. The active component gathers additional specific statistics based on results of an event correlation engine. In operation, if the passive component determines that an issue is present with a server, active component gathers additional server statistics. Likewise, if an issue is discovered in a subnet, active component gathers additional network statistics. Thus, any response-time issues in a network are isolated using additional data. The additional data can be collected via one or more modes, including a snapshot mode and a continuous collection mode.

Investigation console component 600 receives the additional data generated by the active component and operates on the received data if available. Investigation console component 600, in an embodiment, is operable whether or not some or any additional data is received from active component.

The console 600 and network performance agents, in one embodiment, include event detection algorithms that are capable of identifying sudden, gradual, and periodic anomalies. For example, an Auto-Thresholding method, described in further detail below, can be configured to generate a separate threshold for each of three or more baselines. One baseline can be based on the past week, one can be based on the same day of week over the past three months, and one can be based on the same day of week similar day of month over the past six months. These baselines are exemplary, and one of ordinary skill in the art will appreciate with the benefit of this disclosure that system requirements can dictate alternate baselining techniques such as hourly thresholds or baselines using workdays only.

The baselines are computed using related historical data that can be weighted according to different means. For example, a network delay metric for a specific service A from a specific site B to a specific server C might be compared against thresholds computed from historical data of the network delays experience by service A for communication between site B and server C located at data farm D. Also, a network delay metric for service A from a specific site B to a specific server C might be compared against thresholds computed form historical data of the network delays experienced by service A for communication between site B and all servers C1-CN that host service A at data farm D, where the measurements from the different servers could be weighted equally or according to their amount of service-related traffic or according to some other means.

The event detection can be triggered a single transaction or behavior, or it can be triggered by a function of the related transactions or behaviors. For example, a single Purchase Order transaction response time exceeding a threshold could trigger an incident; similarly, the average of the Purchase Order transaction response times in a 5 min interval exceeding a threshold could trigger an incident. The function can be arbitrary and include different forms of weighting to aggregate the related measurements. The weighting can be based for example on the type of service, the user, the server, and the underlying measurement type.

An Auto-Thresholding method according to an embodiment reports a single threshold from the weighted average of the three baseline thresholds, where each baseline may itself be a weighting of related measurements as explained above. Performance agent 670 can be configured to instead check data against the individual baseline thresholds and record which baseline(s) was violated.

A violation of the 6-month threshold but not the 7-day threshold could indicate a gradual increase condition; the hypothesis could then be confirmed by inspecting time-series event data. Similarly a violation of the 7-day threshold but not the six-month threshold could indicate either a periodicity or a recent jump.

In one embodiment, a network performance agent 670 with an active investigation component has two modes, snapshot and continuous.

The snapshot mode exhibits activity only when triggered by an event. More specifically, in snapshot mode, the active investigation component only provides a snapshot of performance around the time of an event. For example, in some networks an appropriate period of time can be about five to 15 minutes from the beginning of an event without any context or historical information. A snapshot mode can be beneficial to those clients that are collecting network and systems data using other tools in addition to a network performance agent in accordance with embodiments herein. For example, such clients, by using additional tools would have to implement double-polling systems if the snapshot mode were not used. Rather than a double-poll system, such clients can refer to their other tools to provide context.

The continuous mode for the active investigation component polls server and/or network information continuously to provide a performance history. According to this mode, performance data can be stored and reported from a network performance agent database, in which case the Event Detection component 680 should also note anomalies in this data. Alternatively the performance data may be stored and handled separately by the Active Investigation component. The continuous mode allows for the reporting not only of instantaneous values but also of whether those values are atypical thereby providing improved automated root cause analysis.

Referring now to FIG. 6B, the investigation console component 600 is shown in further detail, including investigator web site 612. Investigator web site includes an investigator user interface that is a web application to provide access into investigator status, configuration, incidents and user-initiated investigations as shown by incident reports 622, current investigations 624, investigator configuration 626 and user-initiated investigations 628. In an embodiment, each of incident reports 622, current investigations 624, investigator configuration 626 and user-initiated investigations 628 interact with an investigator console library 632.

Active investigator 620 can be coupled to a host of active investigator web services, which can include ping, trace route, TCP Echo, TCP trace route, agent query, SNMP query, and router query.

FIG. 7 is a flowchart of a portion of an Examine Metrics process 300 for analyzing the data collected by Service Monitor 125. A metric can be an individual transaction measurement such as the network delay component of the Purchase Order (service A) transaction response time between user B and server C or a function of related metrics such as the weighted average of the Purchase Order (service A) transaction response times between users at site D and servers C1-CN in a 5 min interval. Process 300 begins in a “Start Examine Metrics” step 301 and control proceeds immediately to a “Wait for Next Set of Metrics” step 303 during which process 300 retrieves as a batch Current Metrics file 171 (FIG. 2B) from data store 123 (FIGS. 2A and 2B).

Control proceeds from step 303 to an “Examine Next Metric” step 305 during which process 300 takes the first unexamined metric from Current Metrics file 171 for examination. Control then proceeds to a “Does Metric Cross Threshold in Specified Direction?” step 307 during which the metric selected in step 305, or “targeted metric,” is compared to a threshold set for that particular metric. Thresholds are stored in and retrieved from Threshold Values file 161 (FIG. 2B) and may be manually configured. Multiple thresholds may be used for a single metric to classify violations according to severity. If the targeted metric exceeds the threshold set for that particular metric, then control proceeds to a Transition Point A, which leads to a portion of process 300 explained in detail below in conjunction with FIG. 8.

If in step 307 the targeted metric does not exceed the corresponding threshold value, then control proceeds to a “Metric Sufficiently Deviate from Normal Behavior?” step 309 during which the targeted metric is subjected to a normality test by being compared to associated information in Historic Data file 157. Historic data file 157 contains information corresponding to historic levels for the targeted metric. In other words, the target metric is checked to see whether or not its current value is in line with previously encountered values, or baselines. If the targeted metric's value sufficiently differs from historic values, then control proceeds to Transition Point A. Otherwise, control proceeds to a “Metric Tracked?” step 311 during which process 300 determines whether or not the targeted metric is one that has been designated as a “tracked” metric, i.e. a metric saved regardless of whether it exceeds a threshold in step 307 or differs sufficiently form normal in step 309. If the targeted metric, is a tracked metric, then control proceeds to a Transition Point B, which leads to the portion of process 300 explained in detail below in conjunction with FIG. 6A.

If in step 311 the targeted metric is determined not to be a tracked metric, then control proceeds to an “More Metrics?” step 313 during which process 300 determines whether or not there are additional, unexamined metrics in Current Metrics file 171. In addition, metrics that have exceeded a threshold or a normality test, diverted for further processing via Transition Point A, and tracked metrics, diverted for further processing via Transition Point B, are reintroduced to More Metrics? step 313 via a transition Point C.

If there are no more additional metrics to be examined, then control proceeds to a “Store Incident Changes to Database” step 317 during which the current metrics, including tracked metrics, metrics that crossed one or more thresholds in step 307 and metrics that failed a normality step in step 309, are stored in a Investigator database 650 so that the data is available for further processing during an Examine Incidents process 351, described in detail below in conjunction with FIG. 9. If there are additional metrics, results may be cached prior to examining the next metric. Thus, optional cache results step 315 is shown prior to returning to Examine Next Metric 305.

Following More Metric Step 313, control returns to Examine Next Metric step 305 and processing continues as described above with the next, unexamined metric designated as the targeted metric.

If process 300 determines in step 313 that there are no more metrics to be processed, then control proceeds to a “Store Incident Changes to Database” step 317 during which all data stored in the temporary file during iterations through step 313 are saved to an Investigator Database 650. In one embodiment, database 123 is implemented as an Investigator database 650, and control updates Incident Data file 167 (FIG. 2B). Finally, control proceeds to an “End Examine Metrics” step 399 in which process 300 is complete.

FIG. 8 is a flowchart of the remaining portion of Examine Metrics process 300 introduced in FIG. 7. The flowchart is entered via one of Transition Points A or B as illustrated above. A target metric is introduced via Transition Point A if the metric either crossed a threshold stored in Threshold Values 161 (FIG. 2B) during step 307 (FIG. 7) or failed a normality test based upon data in Historic Data 157 (FIG. 2B) during step 309 (FIG. 7), or, in other words, a “metric anomaly.” From Transition Point A, control proceeds to an “Incident Open?” step 321 during which process 300 determines whether or not the targeted metric corresponds to a previously opened incident, i.e. an incident that is already being tracked in response to another metric anomaly. Data on open incidents and corresponding issues are stored in Incident Data 167 which can be located in investigator database 650 or data store 123 (FIG. 2B) of data store 123. As one of skill in the art will appreciate, data store 123 can operate as investigator database 650.

If, in step 321, process 300 determines there is no corresponding open incident, then control proceeds to a “Create Incident” step 323 during which a new incident entry is created in Incident Data 167. Control then proceeds to a “New Issue?” step 325 during which process 300 determines whether or not the targeted metric represents a new issue or one that is already being tracked. Of course, if step 325 is entered via step 323, the targeted metric represents a new issue because the incident is new. Control can also proceed to step 325 if process 300 determines in step 321 that the targeted metric corresponds to a previously opened incident. In this case, there might be a previously opened issue that corresponds to the targeted metric.

If process 300 determines that the target metric does not correspond to a previously opened issue, then control proceeds from step 325 to an “Add New Issue” step 327 during which an additional issue entry is added to the corresponding incident entry in Incident Data 167. Control proceeds to an “Update Issue Within Incident” step 329 if process 300 determines in step 325 that the targeted metric is not a new issue. Further, control can proceed to step 329 directly from step 311 (FIG. 7) if the targeted metric is a metric that has been designated as a tracked metric. During step 329, regardless of whether control is passed from step 311 or 329, process 300 updates Incident Data 167 to reflect any information represented by the targeted metric.

Control proceeds from step 327 or 329 to a “Configured To Investigate?” step 331 during which process 300 determines whether or not the tracked metric corresponds to a device, service or metric type that process 300 is configured to investigate. If so, control proceeds to an “Issue Severe?” step 333 during which process 300 determines whether or not the current issue is sufficiently severe or important to trigger an active investigation. If the current issue is severe enough to initiate an investigation, then control proceeds to an “Investigate” step 335. Investigate step 335 includes investigating based on metric type, device and service. In an embodiment, active investigations are launched automatically to collect more data based on the state and type of issue within the incident. If the current issue is not severe enough to investigate or upon completion of the configured investigation, then control proceeds to a “User Notification Required?” step 337 during which process 300 determines whether or not computing environment 100 shown in FIG. 2A is configured such that this particular type of issue requires that a user notification be sent. Control is also passed to step 337 if the Service Monitor has not been configured to investigate the incident.

If process 300 determines, in step 331, that system 100 is not configured to investigate the current issue or, in step 333, that the issue is not severe enough to trigger an investigation, then control proceeds to User Notification Required step 337. Information regarding whether or not a particular issue corresponds to a service or device that is configured for an investigation is stored in Server Settings 163. Information regarding whether or not notification is required is stored in Current Configuration 169. Information regarding whether or not a particular issue is severe enough to trigger an investigation is stored in Investigation Settings 165.

If, in step 337, process 300 determines that notification is required by the particular issue, then control proceeds to an “Issue Severe?” step 339 during which process 300 determines whether or not the current issue is severe enough to trigger a notification. If so, then control proceeds to a “Notify Users” step 341 during which relevant messages corresponding to the current issue are transmitted (for example, by email or pager) to appropriate users. Finally, following step 341, control proceeds to a Transition Point C which returns control to Another Metric? step 313 (FIG. 7). Control also returns to step 313 via Transition Point C if process 300 determines either, in step 337, that notification is not required or, in step 339, that the current issue is not severe enough to trigger a user notification.

FIG. 9 illustrates a flowchart of an Collect Data process 350 that periodically retrieves and processes the results of Cache Results step 315 (FIG. 7). It should be noted that within FIGUREs solid lines connecting steps represent control flow and dashed lines between steps, data stores and data caches represent either the retrieval or storage of information.

Process 350 begins in a “Start Examine Incidents” step 351 and control proceeds immediately to an “Import Collector Files” step 353 during which process 350 retrieves collector files stored in Current Metrics directory 171. Agents on each computing device coupled to system 100 collect metrics corresponding to processes, services and devices and transmit those metrics to server 121. Control then proceeds to a “Save Copy” step 355 during which process 300 saves a copy of the collector files for archival purposes.

Control then proceeds to a “Process and Delete Files” step 357 during which process 350 combines all the collector files into a single, summary file and then deletes the collector files. Control then proceeds to a “Transform Data” step 359 during which the summary file is processed. Control then proceeds to an “Add Data” step 361 during which process 350 adds appropriate transformed data.

Once data in the summary file has been processed in step 357 and any additional data added in step 359, the summary file is saved to a data cache 363 and control proceeds to a “Wait For Files” step 365 during which process 350 waits for more collector files to be generated. Once new files have been generated, control returns to step 357 and processing continues as described above. It should be noted that there is no “End” step in process 350 because once initiated, process 350 continues to run until system 100 is brought down or process 350 is expressly halted by a system administrator.

FIG. 10 is a dataflow diagram showing various data sources of a Threshold cache 373 employed in the claimed subject matter. An “Auto-Threshold Generator” 371 processes data from Historic Data 157 (FIG. 2B) and Sensitivity Data 159 (FIG. 2B, 6) to produce Threshold Values 161 (FIG. 2B, 6). As explained above in conjunction with FIG. 7, Historic data file 157 contains information corresponding to historic levels for metrics. For example, Historic Data may include information on typical network loads during particular time periods. Sensitivity Data 159 contains information related to various tolerance associated with particular metrics. For example, Historic Data 157 may have information indicating that typical response times for a specific service provided by Application Server 111 of system 100 on Monday mornings between 8:00 and 9:00 am varies between 3.1 and 3.7 sec. Sensitivity Data 159 may store information indicating that this service is important, so smaller deviations from the baseline should trigger an investigation. Auto-Threshold Generator 371 combines the historical quality information with the sensitivity information to arrive at actual thresholds values, such as 4.0 sec for a “Degraded” incident and 4.3 sec for an “Excessive” incident, during the time interval in question. This data, which corresponds to actual threshold values for the service, is stored in “Auto Threshold Values” 161. Auto Threshold Values 161 is then employed to create a Threshold Cache 373.

FIG. 11 is a flowchart of an Investigate process 380 that is executed in conjunction with Active Component 153 of Service Monitors 125(1,2,3) of FIG. 2B. Process 380 begins in a “Start Investigate” step 381 and control proceeds immediately to an “Assign Events” step 383 during which events recorded in Data Cache 363 (FIG. 7) are assigned to open incidents, which are stored in an Open Incident List 387. The assignment may result in the splitting or merging of existing incidents. Prior to the processing of step 383, Data Cache 363 is processed by a “Mark Data” step 385 during which events stored in Data Cache 363 are marked as “Good,” “Normal,” Ignore,” “Missing” or “Bad” based upon corresponding data in Threshold Cache 373 and Server Settings file 163 (FIG. 2B). Server settings 163 stores information related to the current configuration of system 100. Mark Data step 385 can be executed automatically at a predetermined periodic interval. For example, system 100, may be configured to execute step 385 every five (5) minutes, independently of process 380.

From step 383, control proceeds to a “Correlate Events” step 389 during which any events labeled “Bad” or “Missing” are incorporated into new incidents. Process 380 then proceeds to a “Conduct Investigation” step 391 during which process 380 determines what steps and devices are involved with an attempt to discover the source of the incident. Information concerning the particular actions and targeted devices is stored in Investigation Settings file 165 (FIG. 2B).

Control proceeds from step 391 to a “Check Availability” step 393 during which time the actions on the devices are executed, if possible (see FIGS. 5 and 6). For example, a lack of traffic on WAN 127 may indicate a problem with a router (not shown) on WAN 127. During step 393, process 380 triggers the execution of an Internet Control Message Protocol (ICMP), “ping” or functionally equivalent inquiry command directed to the router to determine whether or not WAN 127 is able to send and receive traffic via the router.

Once a targeted device has been tested for availability, control proceeds to an “Update Incidents” step 395 during which Incident Data file 167 is updated to reflect both new information on existing incidents and any new incidents created. Thus, the next iteration of process 380, Open Incident List 387 contains current information. Finally, control proceeds to a Send Notification” step 397 during which appropriate users are notified of new and closed incidents. Control then proceeds to an “End Investigate” step 398 indicative of the completion of process 380.

FIG. 12 illustrates a flowchart of an Examine Incidents process 400 that periodically retrieves and processes the results of Cache Results step 315 (see note above, FIG. 7). Process 400 begins in a “Start Examine Incidents” step 401 and control immediately proceeds to a “Retrieve Next Open Incident” step 403 during which process 400 retrieves the temporary file or cached information in step 315. As explained above, the temporary information includes data such as, but not limited to, metrics that exceeded a configured threshold in step 307 (FIG. 7) and metrics that failed a normality step in step 309 (FIG. 7). Control then proceeds to an “Examine Next Incident” step 405 wherein one of the incidents found is examined. Control then passes to an “Examine Issues” step 407 wherein the incidents are further examined to include issues attendant to each incident. The Examine Issues step includes processing the issues according to process 407, described below.

Control proceeds to “All Issues Closed?” step 409 wherein process 400 determines whether issues are closed. If so, control proceeds to “Close Incident” step 411, followed immediately by “Notify Users” step 413 wherein users are notified that the incident has been closed if the system is so configured. Following the notification of users, control passes to query step “More Incidents?” 415, wherein process 400 determines whether or not there are any more incidents to be examined. [0117] If, in step 409 all issues are not closed, process 400 proceeds to “More Incidents?” query step 415. If more incidents are present to be examined, control returns to step 405 Examine Next Incident. If all issues are closed for a given incident and no further incidents are present, control proceeds to “Store Changes” step 417 wherein any incident changes are stored to a database, such as data store 123. Control proceeds to “Sleep” step 419, wherein process 400 waits for a predetermined period of time before returning to examining incidents at step 401 to perform the process again.

FIG. 13 provides a dataflow diagram of process 407, first introduced in FIG. 12. More particularly, process 407 begins with “Start Examine Issues” step 421 and proceeds immediately to “Examine Next Issue” step 423 to pull any issue for a given incident into the process. Control then passes to “Recent Measurements?” query step 425 wherein it is determined whether there have been recent availability or performance measurements. If not so, control passes to “Set Issue State” step 427 wherein the issue state is set to indicate that no recent observations have been seen. Control then passes to “Wait Enough?” query step 429 wherein process 407 determines, given the predetermined timings for incident checking and the like, whether a long enough time period has elapsed for a problem to reoccur. If not, control passes to “More Issues?” query step 435. If the time period that elapsed is enough to determine whether the problem should have reoccurred, control passes to “Close Issue” step 433 and then to “More Issues?” query step 435.

If the examination of an issue reveals that recent availability or performance measurements have taken place in query step Recent Measurement? 425, control passes to “Good State?” query step 431 wherein process 407 determines whether or not the issue is in a good state. If the issue is in a good state, control passes to Wait Enough? query step 429, described above, or passes to More Issues query step 435, also described above.

If there are no more issues that require attention, control is passed to End Examine Issues step 437.

1. A method for server-side monitoring of a computing environment, the method comprising:
monitoring application network transactions and behaviors for the computing environment, the computing environment including one or more client subnets accessing one or more servers, the monitoring capable of being independent of client site monitors;
decomposing the monitored transactions and behaviors into at least network, server and application quality components where a quality component may be based on performance or availability;
using the decomposed quality components to identify one or more of the services, servers and client subnets as being associated with a quality issue; and
implementing an active investigation on the one or more services, servers and client subnets, the active investigation including gathering statistical data to assist root cause analysis independent of a network monitoring interruption.

2. The method of claim 1 wherein the decomposing is based on response size.

3. The method of claim 1 further comprising:
analyzing the decomposed components to identify anomalies, reduce alarms, perform an active investigation, and further isolate an identified problem.

4. The method of claim 1 wherein if the element with an identified problem is a server, the statistical data includes server statistics and if the element with an identified problem is a client subnet, the statistical data includes network statistics.

5. The method of claim 1 wherein the active investigation enables retrieval of specific information to isolate one or more quality issues.

6. The method of claim 1 wherein the server-side monitoring of the computer environment is independent of whether the active investigation retrieves statistics.

7. The method of claim 6 wherein the active investigation can retrieve none, some, or all statistical data to assist identifying a root cause of a quality issue.

8. The method of claim 1 wherein the active investigation includes one or more of a continuous mode and a snapshot mode.

9. The method of claim 8 wherein the snapshot mode is operational only when triggered by an event, the snapshot mode providing a snapshot of performance around a predetermined period of time.

10. The method of claim 9 wherein the snapshot is about five to 15 minutes from the beginning of an event, the snapshot independent of context or historical information.

11. The method of claim 8 wherein the continuous mode polls a source of information continuously to provide a performance history.

12. The method of claim 8 wherein the continuous mode stores and reports performance and availability data in a database wherein the event detection data concerning anomalies in the computer environment are stored.

13. The method of claim 8 wherein the continuous mode stores and reports performance data in a dedicated database for active investigations.

14. (canceled)

15. (canceled)

16. (canceled)

17. (canceled)

18. (canceled)

19. (canceled)

20-60. (canceled)

61. A method of collecting data processing system status information, comprising: monitoring network communications with the data processing system to observe at least one transaction associated with the data processing system; analyzing the at least one transaction to determine if the at least one transaction complies with a quality standard; generating a trigger based on the analysis of the at least one transaction; and collecting system status information responsive to the generation of the trigger.

62. The method of claim 61, wherein collecting system status information comprises collecting system status information so that collection of the system status information automatically time correlates the collected system status information with the trigger.

63. The method of claim 61, further comprising: monitoring a plurality of network communications; and identifying respective ones of the plurality of network communications so as to establish network communications associated with the at least one transaction.

64. The method of claim 61, wherein generating a trigger based on the analysis of the at least one transaction comprises: correlating a plurality of events associated with at least one transaction to provide related events; comparing a value associated with the related events with a threshold value; and generating a trigger responsive to the value associated with the related events meeting the threshold value.

65. The method of claim 64, further comprising: weighting the related events to provide weighted correlated events; wherein comparing a value associated with the related events with a threshold value comprises comparing a value of weighted correlated events with the threshold value; and wherein generating a trigger responsive to the a value associated with the related events meeting the threshold value comprises generating a trigger responsive to the value of the weighted correlated events meeting the threshold value.

66. (canceled)

67. (canceled)

68. The method of claim 61, wherein the quality standard comprises a quality associated with results of a function associated with the at least one transaction.

69. (canceled)

70. (canceled)

71. (canceled)

72. A method of collecting data processing system status information, comprising: generating a trigger based on a measure of quality of content of transactions associated with the data processing system; and collecting system status information responsive to generation of the trigger so that collection of the system status information automatically time correlates the collected system status information with the trigger.

73. (canceled)

74. (canceled)

75. (canceled)

76. (canceled)

77. (canceled)
